(19) United States
(12) Patent Application Publication
(10) Pub. No.: US 2010/0099069 A1
(43) Pub. Date: Apr. 22, 2010

(54) METHOD FOR VERIFYING ANSWERS INPUT INTO A QUIZ COMPUTER

(75) Inventor: Andreas Unsicker, Regensburg (DE)

Correspondence Address: MAYER & WILLIAMS PC, 251 NORTH AVENUE WEST, 2ND FLOOR, WESTFIELD, NJ, 07090, US

(73) Assignee: Umediaentertainment GmbH, Gutersloh (DE)

(21) Appl. No.: 12/645,356

(22) Filed: Dec. 22, 2009

Related U.S. Application Data
(63) Continuation of application No. 10/399,917, filed on Oct. 14, 2003.

(30) Foreign Application Priority Data
Oct. 10, 2000 (DE) 100 50 302.0
Mar. 8, 2001 (DE) 101 12 322.1

(51) Int. Cl. G09B 7/00

(52) U.S. Cl. 434/323

(57) ABSTRACT

The invention relates to a method for verifying answers of a quiz game that are input into a quiz computer, which comprises an input keyboard, an OK key, a display and a computer unit that is equipped with a read-only memory unit containing an operating program, said operating program coding for a method for evaluating answers input by means of the input keyboard during a quiz game, said operating program coding for the generation of control and/or confirmation data from input answers, said operating program coding for at least one security feature from the group consisting of the generation of a device time initialized by the actuation of a key, the generation of a random data word upon actuation of a key, and the combinations of the prominent security features, and said security feature in addition to the control and/or confirmation data being transmitted to a game organizer and verified at that location, and a program coding for such a method and a quiz computer for carrying-out such a method.

### STATEMENT OF RELATED APPLICATION

This application is a continuation of U.S. patent application Ser. No. 10/399,917, filed Apr. 8, 2003, entitled “Method for Verifying Answers Input Into A Quiz Computer, which is a U.S.C. 371 of International Patent Application Number PCT/DE01/03900, filed Oct. 10, 2001, also entitled “Method for Verifying Answers Input Into A Quiz Computer.” Each of the prior applications is incorporated by reference herein in its entirety.

The invention relates to a method for verifying answers of a quiz game that are input into a quiz computer, which comprises an input keyboard, an OK key, a display and a computer unit that is equipped with a read-only memory unit containing an operating program, said operating program coding for a method for evaluating answers input using the input keyboard during a quiz game, said operating program coding for the generation of control and/or confirmation data from input answers, and said control and/or confirmation data being transmitted to a game organizer and verified at that location. The invention also relates to a program that codes for a method of the aforementioned type and to a quiz computer comprising an operating program that codes for such a method.

### BACKGROUND OF THE INVENTION

If a game organizer intends to have a multitude of media users participate with offered winnings by using these media, for instance television, radio or print media, sufficient security features will have to be provided that exclude cheating by a user. In case of very high winnings, these security features will have to be particularly reliable.

Typically, the lotto coupon principle is employed, wherein a user has to transmit to the game organizer a document provided with his solutions or his numbers at a certain time prior to the publication of solutions or numbers. This is expensive, in particular for the evaluation by the game organizer, since all documents have to be checked, irrespective of the fact that only a few winners are among them. Further, in particular in the case of television quiz shows (or bingo games etc.), the TV viewers cannot participate in real time during the show. If however a real time participation of for instance TV viewers is provided, then special security measures against cheating are necessary, at least if it is intended to disclose the results or winners already during the show or in close time, what is in most cases desirable for psychological reasons.

### DESCRIPTION OF RELATED ART

From the document DE 198 19 920 C2 are known in the art a quiz computer and an operating program for such a quiz computer, wherein to an answer input by the user (answer data word) a control data word and a confirmation data word are assigned. The three data words are linked to each other by defined algorithms, i.e. an answer data word deemed “right” and only this one produces a control data word and a confirmation data word, which are recognized by the organizer as verifying for the “right” answer data word. It is understood that the algorithms are not known to the users. This concept has proven useful, may however still be improved with regard to the security features.

From the document WO 99/57666 a quiz computer according to the above document is known in the art, wherein in addition the date and time can be displayed and stored for documentation purposes. This special embodiment has not proven useful, since either high efforts for a sufficiently precise internal clock have to be spent, or the quiz computer due to the deviations of the time calculated by the computer has a limited time of use only. Insofar the thus known security feature storing date and time together with other documentation data is not satisfying. The requirement of a simple and economic design is particularly important, since such a quiz computer is a mass product, which further will also be distributed at least in part as a commercial gift free of charge.

### TECHNICAL OBJECT OF THE INVENTION

The invention is therefore based on the technical object to provide a quiz computer and a method for verifying answers input thereinto, wherein by simple and economic means an improved documentation and security against not allowed manipulations of the quiz computer are secured.

### SUMMARY OF THE INVENTION

For achieving the above technical object, the invention teaches a method for verifying answers of a quiz game that are input into a quiz computer, which comprises an input keyboard, an OK key, a display and a computer unit that is equipped with a read-only memory unit containing an operating program, said operating program coding for a method for evaluating answers input using the input keyboard during a quiz game, said operating program coding for the (defined) generation of control and/or confirmation data from input answers, said operating program coding for at least one security feature from the group consisting of “the generation of a device time initialized by the actuation of a key, the generation of a random data word upon actuation of a key, and the combinations of the prominent security features”, and said security feature in addition to the control and/or confirmation data being transmitted to a game organizer and verified at that location.

It is achieved by the invention that by means of the device time(s) a simple verification is possible, and that without expensive precisely working clock functions. Time differences only between an initializing key actuation and another result, for instance of a subsequent key actuation or a readout are determined. Since such time differences add up to hours at most, rather high deviations in the components affecting the time function (quartz of a processor, RC circuit or the like) are acceptable. Nevertheless a reliable verification can be made by using the time differences. If for instance a read-out device time is smaller than the time elapsed since a defined input time limit, then this means that an input was made after the input time limit only. In detail, the most various verification methods are found, and reference is made to the examples of execution. The random number can also be used for verification purposes, since if a transmitted random number and the random number stored in the quiz computer used for checking and belonging to the transmission do not agree, a manipulation, for instance a submission of a falsified quiz computer has taken place.

It is preferred that the security feature consists in the generation and indication on the display of the device time initialized by a key actuation. The security feature of the random number may as an option additionally be provided.

In principle, the initialization of the device time may be made by any key actuation, provided the key actuation selected and programmed correspondingly is deemed suitable for the verification during the course of the game. Typically, such key actuation means a multiple function, i.e. the initialization is made together with the main function started by the key actuation (for instance select game, input answer etc.). It is preferred that the initialization of the device time is effected by the actuation of a letter key or a game selection key or the OK key.

For the purpose of the invention it is possible to use several device times. Then the initialization is effected for instance by different key actuations. It is however also possible to initialize several device times with one key actuation. Different device times may also be stopped independently from one another, or may be continuous, as will be described below in more detail.

The start values and time increments of the device time are fully freely selectable and definable. In particular, the device time needs not be counted in usual units. For reasons of simplicity, it is however preferred that the device time is initialized at a start value of 0 and/or the device time has the format hh:mm:ss or mm:ss (h=hours, m=minutes, s=seconds). A simplification with regard to structure and operating program can also be achieved by that the device time runs in increments of 1 to 30 s, preferably 1 to 10 s, for instance 5 s, and/or is shown on the display.

In detail, there are various variants for the verifications to be applied. For instance, the running device time may not be stoppable by an operation of the quiz computer. Then the device time runs beginning with the initialization till the time of a readout (and possibly further). The running device time may however also be stoppable by actuation of a lock key, and the value of the stopped device time may be storable in an documentation memory. Then a verification is independent from the time of readout. The device time, running or stopped, may be showable on the display by means of a key actuation. This may be a key actuation to be effected by the user and/or a so-called operator code, typically a combination of keys solely known to a game organizer or a person authorized for the verification. Such an operator code can also be used for other readouts from memories of the quiz computer, for instance answers or numbers, confirmation data words, control data words, random numbers etc. Then a readout and verification is particularly simple, namely by the anyway existing display and comparison with the required values by an operator.

The invention also relates to a program that codes for a method according to the invention, a quiz computer, which comprises a keyboard, an OK key, a display and a computer unit that is equipped with a read-only memory unit containing an operating program, said operating program coding for a method according to the invention. The invention finally relates to the carrying-out of different games according to the examples of execution.

A quiz computer according to the invention may be configured in a concrete manner. It may be a mono-functional unit, i.e. it is adapted for carrying out the quiz computer functions only. It may however also be a multi-functional unit, for instance a PC or a mobile telephone. In the latter case, a transmission of data to a game organizer can easily be integrated, for instance by linking dialing sequences of the telephone with operation functions of the quiz computer (for instance of the lock key). In case of the PC, a key actuation may be effected by using the keyboard of the PC. It is however also possible that the quiz computer is configured in a virtual manner, i.e. the quiz computer with its keys is represented on the monitor of the PC. Then a key actuation is for instance made by touching the shown keys (touch screen) or by means of a cursor moved to the picture of the key (mouse, track ball, touch pad, joy stick etc.).

A preferred method according to the invention is characterized by that the device time is initialized by a defined first key actuation, wherein the device time is read out on the display as a response to a subsequent second key actuation determined by the game organizer, and being transmitted by an operator to the game organizer, by the game organizer a verification of the time of the first key actuation after or before, resp., a given earliest or latest time, resp., of an admissible input of an answer being performed by comparison of the transmitted device time to a minimum or maximum reference time, resp., calculated from the time difference between the earliest or latest time, resp., of an admissible input of an answer and the time of the second key actuation. In other words, the procedure is as follows. At an earliest or latest time, resp., of an admissible input of an answer, a game organizer device time is initialized and represents in case of a readout by the game organizer at the time of the second key actuation (see below) the reference time. For the purpose of a verification of the results of an operator for instance contacting by telephone, the operator is required to carry out the second key actuation with the consequence of the readout of the device time and transmission of the read-out device time to the game organizer. By comparison of the transmitted device time to the reference time, it can then be determined whether the first key actuation was effected before the earliest or after the latest time, resp., of an answer (first key actuation—then inadmissible answer input) or not (then admissible answer input).

It is preferred that the device time is encrypted before readout, the transmitted encrypted device time being either first decrypted at the game organizer's location and then compared to the reference time or being compared to the reference time encrypted before. Encrypting may in principle be made in an arbitrary manner. A suitable encrypting is for instance the conversion described in the following in another connection into a number system with the base>10. Such a type of encrypting not only has the advantage that a person not knowing the base cannot make any intentional faulty entries (if at all, guessing might be used). Rather, the higher base permits a smaller number of digits than for instance the decimal system, so that the transmission in particular by telephone is easier and less complicated. A number system with the base 26 is for instance the alphabet. A digit can be one of the 26 letters of the alphabet. The sequence can be defined in an arbitrary manner. A number system with the base 36 is the alphanumeric system, i.e. comprising the 26 letters of the alphabet and the 10 numbers “0” to “9”. In the examples, the system of 26 is used with an increasing value from 1=“A” to 26=“Z”. In the case of the system of 36, 1=“A” . . . 26=“Z” and 27=“0” . . . 36=“9”.

With the second defined key actuation or a third defined key actuation, a random data word can be generated, the random data word being transmitted together with the device time to the game organizer. This permits in particular that the device time is subjected before readout to a linking operation with the random data word to generate a combination data word, that the combination data word is subjected by using the transmitted random data word at the game organizer's location before the comparison to an inverse linking operation, a device time being obtained thereby, or that the reference time with the transmitted random data word is subjected at the game organizer's location before the comparison to the linking operation. In other words, first a linking of the device time with the generated random data word, for instance by an operation of the four basic arithmetical operations, and then a transmission of the combination data word and of the random data word is performed. At the game organizer's location either a corresponding linking of the transmitted random data word with the reference time and then a comparison, or a “delinking” of the transmitted combination data word with the transmitted random data word and comparison of the device time thus obtained in “clear text” to the reference time takes place. This embodiment of the invention has the particular advantage that the device time needs not continue running after the second (or last, see below) key actuation, in order to permit a verification of the quiz computer submitted to the game organizer in case of a win by a following direct readout of device time and random data word at the game organizer's location. Rather, the verification may be limited to the readout of the transmitted information. This is an additional protection of the quiz computer from manipulations, by means of which the time circuits of the electronic circuitry determining the device time could be influenced (for instance heat/cold, magnetic fields etc.). Such an influencing to cause a quicker or slower running is the better possible, the longer the quiz computer can be subjected to such influences. In the above embodiment, only the time between the first and second key actuations is available and not the typically much longer time till a subsequent submission of the quiz computer to the game organizer.

As explained above, the encrypted device time or the combination data word can be converted into a number of a number system with a base>10, in particular >20, for instance 26 or 36, and the values up to 26 of the decimal system are for instance the letters of the alphabet and as an option the values 27 to 36 of the decimal system are the numbers “0” to “9”. Either a reconversion of the device time or of the combination data word into the number system of the reference time is made by the game organizer before the comparison, or the reference time is converted into the number system of the device time or of the combination data word before the comparison.

For control purposes, in particular against guessing purely by chance the device time, combination data word and/or random data word by an operator with cheating plans, readout and transmission of the device time, of the combination data word and/or of the random data word may be performed several times in succession, for instance two times. The statistic probability of combinations guessed several times purely by chance is extremely low.

Professional cheaters will not have—except by a possible contactless influencing of the device time—any motivation for the transmission of device time, combination data words and/or random data words determined by means of algorithms of the quiz computer known by hacking, since on one hand the particulars of an operator calling the game organizer by phone (for instance for the purpose of the price draw) are checked, and on the other hand a “final check” by submission and examination of the quiz computer takes place at the game organizer's location. Since the transmitted data are also stored in the quiz computer, the game organizer will read them out for verification. A storage of false values can however be prevented by simple constructional methods, such as for instance a welded enclosure.

It is achieved, by the invention, that a verification of an input for an input time of answers is possible by telephone communication within an answer time span determined by the game organizer.

### DEFINITIONS

A quiz computer is an electronic device by means of which users can participate in various games organized by a game organizer by that the users make inputs according to the rules of the game, and the inputs by the quiz computer or user are then verified for correctness, i.e. match with the instructions of the game organizer (right/wrong, win/blank etc.).

As games, in particular games with winnings are considered. Examples are lotto, football pools, bingo, question/answers quiz, guessing games etc.

An input keyboard comprises a plurality of keys, to each key a specific symbol being assigned by means of the operating program. These may be numbers, letter, characters or other symbols.

An OK key is an input actuation key, by means of which an input by means of the input keyboard is terminated. Other terms are return key or enter key.

Corresponding acoustic commands to a microphone or the like connected to the computer unit are in principle equivalent to a key actuation.

A display is for instance a constructional unit on which by means of the operating program symbols of the above type can optically be represented. For the purpose of the invention, the term display however comprises other output techniques, too, such as acoustic outputs.

### BRIEF DESCRIPTION OF THE DRAWINGS

FIG. 1 illustrates a quiz computer operating according to the invention;

FIG. 2 illustrates electronic circuitry according to the invention;

FIG. 3 illustrates the steps integrated into the operating program for the game function bingo;

FIG. 4 illustrates the steps integrated into the operating program for the game function guessing;

FIG. 5 illustrates the steps integrated into the operating program for a multiple-choice quiz;

FIG. 6 illustrates the processes allowing a game organizer to announce the correct answer immediately after each question and expiration of the guessing time difference.

### DETAILED DESCRIPTION OF THE INVENTION

A computer unit is a conventional processor system well known to the man skilled in the art. Hereto belongs a read-only memory (ROM, PROM, EPROM) where the operating program for the processor unit is stored. Hereto belongs further a writable memory (RAM) where the processor unit can store or possibly also read out data. The writable memory is typically split up in certain sections, for instance address sections, which are used by the processor unit in the course of the execution of the operating program (operating memory), and address sections where for instance answer data words, control data words, confirmation data words and/or device times are permanently stored till readout (documentation memory).

A device time is a relative time (measuring) function, the beginning, end and increments of which are independent from an absolute real time or standard time. The insofar obtained device time values do not have any fixed correlation with a standard time, since the values are independent from the variable (absolute) time of an initializing key actuation. A device time is always a time difference between an initializing event, for instance a key actuation, and a later further event, for instance a key actuation or readout of the actual value of (continual) device time function.

A random data word is a data word generated by means of computer unit by a random number algorithm provided in the operating program.

A security feature is a data information which for the purpose of the verification can be checked for agreement or defined correlation with a reference information given by a verifying station. The check can be made by a person, however also fully automatically by means of readout devices and the like.

The start value of a device time is the number to which the computer unit adjusts a counter for the time increments at the initialization or the (actuation) event coding herefor. A stopped device time is obtained, when the counter has been stopped in response to another (actuation) event. A fixed difference time between the two events is obtained. A running device time is however not stopped. The time difference between a readout and the initializing event thus depends from the time of readout.

A lock key causes a storage of all data words relevant for a verification in the documentation memory. A user cannot change the contents of the documentation memory.

A transmission of data or security features to a game organizer may be performed in the most various ways. A simple transmission is the telephone information (fixed or mobile networks). However, remote transmission of data (internet), blue tooth etc. is also possible. Finally, a transmission may also comprise the submission of a quiz computer to a game organizer who then reads out the data. Combinations of the above transmission paths may also be provided.

### EXAMPLES OF EXECUTION

### Example 1

### The Quiz Computer According to the Invention

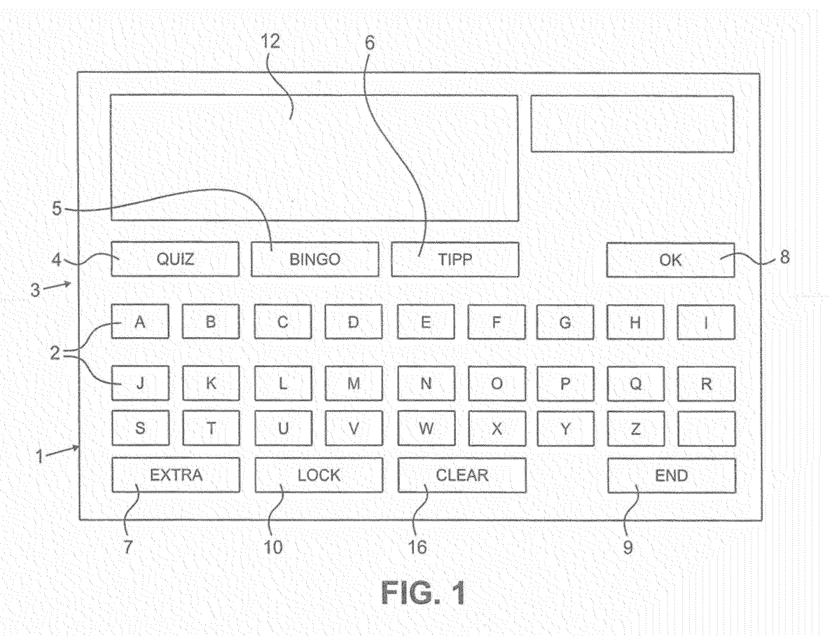

In FIG. 1 is shown a quiz computer operating according to the invention. The quiz computer comprises a letter keyboard 1 with one letter key 2 each for each letter of the alphabet, a game selection keyboard 3 with the keys 4, 5, 6 and 7 for the selection of the desired game, an OK key 8, an end key 9, a lock key 10, an off key 11 and a display 12. Some letter keys 2 are highlighted, since they can be used for multiple functions. Further a clear key 16 is provided. In the display 12, various information can be represented, which will be described in the following in the examples.

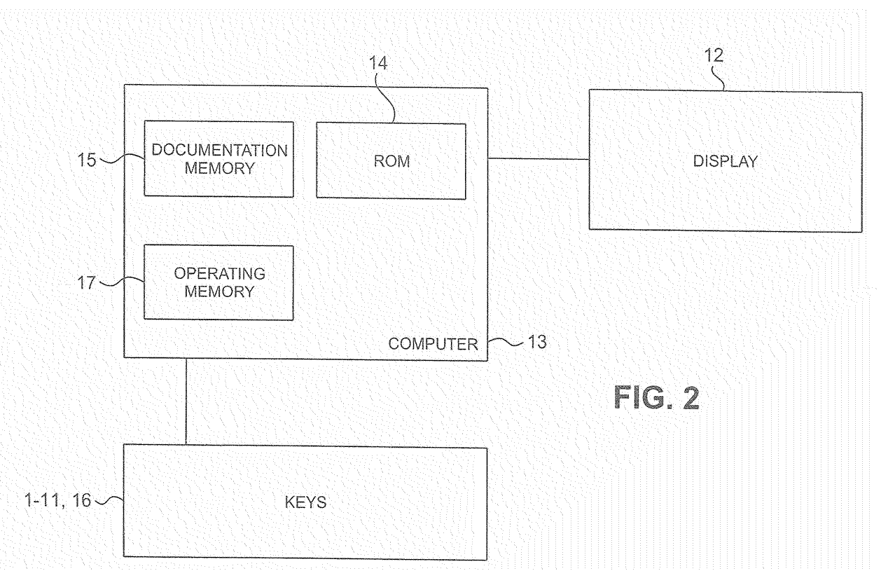

The electronic circuitry comprises according to FIG. 2 a computer unit 13 with an operating program stored in a read-only memory 14. The computer unit is connected with the keys 1 to 11 and 16 and is controlled thereby. The display 12 is also connected with the computer unit 13 and outputs in an optical way information determined by means of the operating program and intended for outputting to a person viewing the system. It is understood that in lieu of or in addition to the display 12, means for acoustically or otherwise outputting information may also be provided. The operating program controls the functions, as explained in the following examples. Therein an operating memory 17 is used for the purpose of an intermediate storage of information in the usual way of a computer system. Furthermore, a documentation memory 15 to be read out by a controlling person, for instance by means of inputting a readout code, is provided, wherein after termination of a game, various data serving for control and/or documentation of the course of the game can permanently be stored. This, too, is explained in detail in the following examples. Operating memory 17 and documentation memory 15 may be combined in one unit having different address regions only.

An essential element of the operating program, independent from the above example, is a clock generator function, by means of which from the clock of a (usual) clock generator of the computer unit 13, clock signals with a time duration of for instance 1/10 s, 1 s or 5 s can be obtained by a divider function. By means of the clock signals, device times can be generated by simple increment generation. A device time is in no way linked to a local time or a standard time nor synchronized therewith. Several different device times may be active, the instantaneous increment value of which being determined by the time difference between the actual moment and a defined event in the past. Such a (triggering) event may for instance be a key actuation on one (or several) key(s) defined by the operating program. In this way, at last time differences between two key actuations defined by the operating program, an initializing key actuation and a terminating key actuation, can be obtained, which in turn serve as input values for other operations of the computer unit or as control values.

A time difference may for instance serve as an initializing value for a random generator. Random generators are programs or program sections, by means of which (virtually) random number or symbol sequences are generated. Usually, an initializing value has to be input, which is then converted by a random generator program into a sequence of symbols. Herein, normally an actuation of a key plays a role, the moment of the actuation in the program steps very quickly sequencing initializing the virtually random sequence of symbols. Random generators are well known to the man skilled in the art and need not be explained here in more detail. A higher randomization is achieved, if a (possibly further) initialization value is (additionally) used as an input value for the random generator program. This (further) initialization value is designated time-in value. This is particularly valuable in connection with game programs based on stochastic processes.

A time difference may however also have pure documentation functions, if it is stored in a documentation memory 15. Then a controlling person can check by means of a readout of the stored time difference, whether the value is consistent with time difference values defined otherwise, or whether there is a (later) manipulation of a game result.

### Example 2

### The Bingo Function

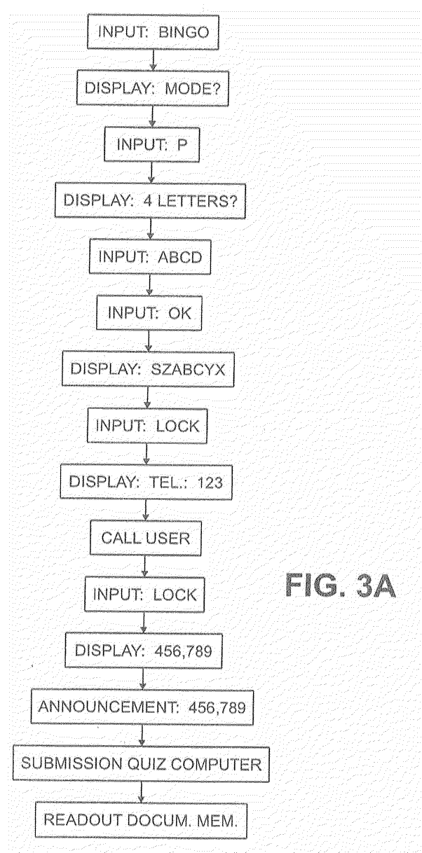

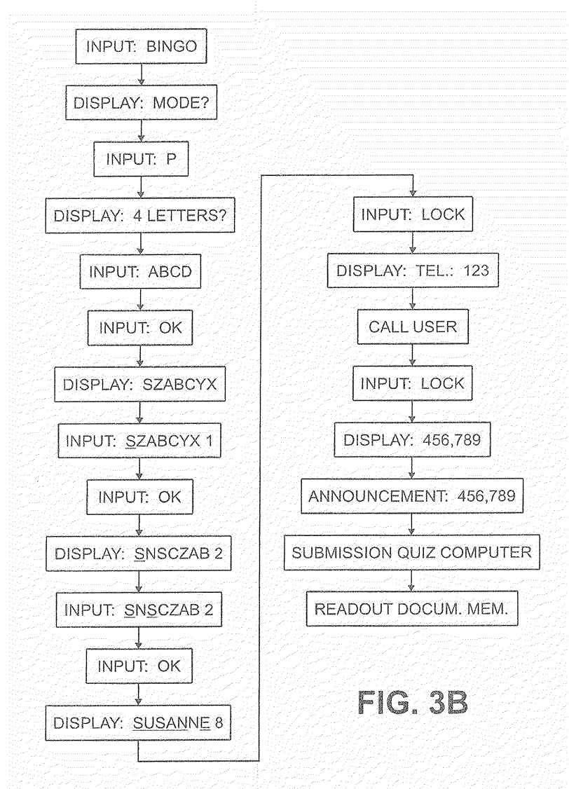

For the game function bingo, the following steps are integrated in the operating program. These steps are also made clear by FIG. 3.

The game is initialized by pressing the bingo key 5 and thus the respective section of the operating program is invoked. After pressing the bingo key 5, a request for inputting the mode appears in the display 12. Then a playing person acknowledges by a letter key 2 assigned to the mode desired by the person. In the example, the assignments according to Tables 1 and 2 are valid.

TABLE 1
bingo numbers

| Letter | Digits of bingo number | Example |
|---|---|---|
| A | 3 digits | 321 |
| B | 4 digits | 4,321 |
| C | 5 digits | 54,321 |
| D | 6 digits | 654,321 |
| E | 7 digits | 7,654,321 |
| F | 8 digits | 87,654,321 |
| G | 9 digits | 987,654,321 |
| H, I and J blocked | | |

TABLE 2
bingo words

| Letter | Number the bingo letters | Example |
|---|---|---|
| K | 3 letters | GUT |
| L | 4 letters | VIEL |
| M | 5 letters | BETTY |
| N | 6 letters | BERNIE |
| O | 7 letters | QRZTSNA |
| P | 8 letters | PROGRAMM |
| Q | blocked | |
| R | 9 letters | RENNWAGEN |
| S | 10 letters | TUNICHTGUT |
| T | 11 letters | BSGWTJFCNEN |
| U | 12 letters | FESTSPEICHER |

In the case of the bingo numbers, a winning number is given by the game organizer and is (as an option) determined in a random manner. A playing person is a winner or a potential winner, if the bingo number appearing in the quiz computer is identical to the winning number (within the group of the potential winners, further criteria, such as order of the calling time, lot etc. may be provided). This applies in an analogous manner to the bingo words, with the particularity that the winning word may well be a given sequence of letters, namely when the winning word makes a sense, for instance the name of company or product. This will lead to that the playing person easily remembers the winning word, since the result obtained in the quiz computer has always to be precisely compared to the winning word. In either case, the selection of the mode serves for that the quiz computer generates a bingo number or a bingo word with the number of symbols corresponding to the winning number or the winning word.

After the mode has been adjusted, the playing person is required in the display 12 to actuate four letter keys 2 on own choice. These are the initialization value. After inputting (if applicable corrected by means of the clear key 16) all letters, the person is required in the display 12 to actuate the OK key 8. By actuation of the OK key, the bingo number or the bingo word is generated by means of the random generator from the input four letters and shown on the display 12. Then, this is however not necessarily required, a time difference may serve as a time-in value for the random generator. The time difference may be any time between two key actuations as explained above. As the beginning and/or end of the time difference, the start and/or end edges (electronically: rising and/or falling edge) of the key actuations may be defined. When the two edges of a single key actuation are defined, the time difference is the duration of actuation. All above possibilities can be combined, for instance by using several time differences as time-in values of the random generator. As a result, a considerable randomization is obtained.

After the display of the bingo number or the bingo word, the operator can compare whether the obtained result corresponds to that given by the game organizer. Normally this will not be the case. Is however agreement, the operator has scored a hit, what the game organizer can reward by a win. In case of a hit (this corresponds to a control data word), the following is made. The operator actuates the lock key 10 with the consequence that no further inputs during the actual game are possible anymore (a new game or also other games may as an option nevertheless be played). Further, a program routine is performed, whereby confirmation data are calculated from the bingo number or the bingo word by a defined mathematical operation, typically a multi or four-digit number. The assignment between control data (bingo number) and confirmation data preferably follows a one-to-one correlation, so that to a specific set of control data, only a specific set of confirmation data is assigned and vice versa. This program routine has been performed in the same way by the game organizer for the given hit. The confirmation data or a part of the confirmation data are shown on the display 12 and comprise a telephone number or a part of a telephone number, for instance the extension of a telecommunication system with a switchboard number known to the operator. The operating person now calls the specified telephone number (control data) in order to announce the hit and call-off a win if applicable. With the defined calculation of the confirmation data at the game organizer's location as well as by the operating person, it is achieved that only such operating persons having a hit will also dial a telephone number where hits can be announced. The other confirmation data or telephone numbers displayed in case of non-hits have either no function or are commented by “sorry, no win” or the like (in case of a non-hit, it is anyway not likely that the operating person will try to give a ring). When the operating person has dialed the telephone number for hits, he is required to actuate again the lock key 10. This again will initialize a program routine wherein by a defined mathematical operation a (further) confirmation number is obtained from the (complete) confirmation data and is displayed, for instance a multi or four-digit number. This may be, also in other embodiments, for instance a simple truncation function. Then a first part of the confirmation data is the telephone number part, for instance 3 digits, of a multi-digit number (the confirmation data word), for instance 9 digits, calculated from the inputs. The (second) confirmation number is then formed by the remaining digits, for instance 6 digits of the confirmation data word. In this case, too, the operations are identical to those being performed at the game organizer's location. The (second) confirmation data are completely shown on the display 12 and are advised by telephone by the operating person upon request. Thereafter, by using the (second) confirmation data, the game organizer checks whether a hit has really been obtained. Since the mathematical operations for calculating the confirmation data and the control data (or of the basic multi-digit number) are unknown to an operating person, it is excluded that an operating person calling by accident the right telephone number and not having obtained however a hit, can act as a winner. This is immediately detected by the comparison of the confirmation data advised by telephone to those calculated by the game organizer. After verification of the confirmation data, the operating person is then required to submit the quiz computer, or the quiz computer is collected, in an analogous manner to a lotto coupon.

Confirmation data and/or control data are stored in the documentation memory after their respective generation, and that in an undeletable manner. As an additional security measure, the game organizer can read out after receipt of the quiz computer then by input of a known or secret operator code the documentation memory and check its contents for correctness. In this connection, a control time can additionally be read out. For instance the actuation of the OK key 8, the first actuation of the lock key 10 or the second actuation of the lock key 10 can be provided as an initializing event. Beginning therewith, time units are incremented, thus a time after the initializing event being defined. When the game organizer synchronously initializes a corresponding device time, for instance with the request for the (2^{nd}) actuation of the lock key 10, then by comparison of the device time of the submitted quiz computer and the device time synchronously initialized with this and only this quiz computer, the game organizer can check for plausibility. Only admissible are (relative) deviations due to quiz computer-typical variations of the clock signals caused by the components (e.g. the quartz).

For a mode with a bingo word, the following variant is possible. Since the probability of a hit with given hits having many symbols is very low, it can be provided that after actuation of the OK key 8 the operating person verifies whether at least one digit is correct at the correct place. If yes, by actuation of the corresponding letter key 2, this correct symbol can be fixed by a defined sequence of keys, by means of which one symbol at the correct place among several correct symbols otherwise however not at the correct place can be selected. Then another cycle beginning with the actuation of the OK key 8 takes place (it is also possible to have the cycle restart at other steps), the fixed symbol being however invariant. Then comparison and new cycles are repeated so often, until the hit is obtained. The number of the cycles are counted and displayed by the computer unit. Then that operating person has won, who has needed the lowest number of cycles. The number of cycles can be stored in the documentation memory by actuation of the lock key 10, equally a complete storage of the course of the game is possible. It is possible to define a maximum number of allowed cycles, and when this number is obtained, another actuation of the OK key 8 is blocked. The maximum number may also be different depending from the mode, i.e. the number of letters of the bingo word, for instance 3 for 6 letters, 30 for 7 letters etc.

The functionalization “bingo” may vary in the following way. The display 12 may comprise a matrix of fields. The matrix may be symmetrical or asymmetrical and may comprise for instance 5 by 5 fields. By actuation of the OK key 8, then by means of the random generator random numbers, for instance having 2 digits, are generated for the fields and placed in the fields. The game organizer for his part has generated a group of bingo numbers, in case of a 5 by 5 matrix at least 5 bingo numbers, and has announced them. When now by actuation of the OK key one or several of the announced bingo numbers appear in the fields of the quiz computer, the operating person can compare these to the announced bingo numbers. If according to usual bingo rules a series has been obtained, for instance in a column, a line or the diagonal all announced bingo numbers, then the operating person is a winner or a potential winner and the steps described above are performed in an analogous manner. It is also possible in this variant, in case of a partial agreement only, to fix individual agreements and to generate the remaining matrix elements once again by the random generator etc., until a win series is obtained, if applicable with a maximum number of cycles as an abortion criterion. For the evaluation as a winner or a potential winner, then in addition to the agreement, the number of trials is also important.

### Example 3

### The Guessing Function

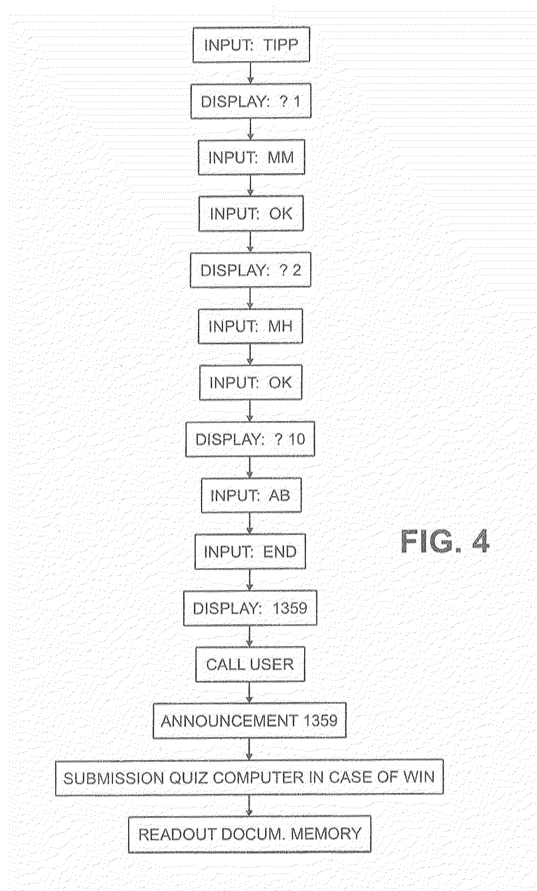

For the game function guessing, the following steps are integrated in the operating program. The steps are also made clear by FIG. 4.

The game is initialized by pressing the guessing (“TIPP”) key 6 and thus the respective operating program part is invoked. After pressing the “TIPP” key 6, in the display 12 appears a request for inputting the guessing for position 1, for instance Max Mueller for winning the formula 1 race. Then a “1” is shown in the display 12, for the guessing on position 1. The input can be made by plain text or also by abbreviations, for instance “MM”. By input of the first guess, the operating program can check the number of input symbols and use this number as a mandatory requirement for subsequent guesses. It will then be suitable, in case of a first input having a certain number of symbols, for instance 3, to cancel the above requirement for the number of symbols for subsequent inputs. Thereby, a full text entry is also possible, wherein the subsequent guesses will have different numbers of symbols. After inputting the first guess and confirming by means of the OK key 8, the input of the next guess, for position 2, is required, then the “2” appearing in the display 12 as a hint to the position. After inputting the second guess, for instance “MH” for Micha Huber on position 2, then again a confirmation of the OK key 8 is made, etc. The last guess however is terminated by pressing the end key 9 (the lock key 10 would also be possible). Then follows an indication of a guess code (control data word or confirmation data word) in the form of a four-digit number on the display 12. The guess code has been calculated by the operating program from the inputs and under consideration of the order of inputs by means of an algorithm suitably being a mathematical function following a one-to-one correlation between the inputs and the guess codes. The user then transmits the guess codes (preferably before the event to which the guess refers, or at a deadline before it) to the game organizer. After the event the game organizer generates with the same algorithm the matching guess code and compares the transmitted guess codes thereto in order to determine a win.

Herein, as an additional security function, a device time can be used, which is initialized by a key actuation, for instance of the “TIPP” key 6, a (for instance first) actuation of a letter key 2, a (for instance first) actuation of the OK key 8 or actuation of the end key 9. If then the game organizer reads after the guessing game the running device time out and calculates from the read-out value, in connection with the real time of the readout, the approximate time of the initialization, quiz computers can be rejected the device time of which is smaller than the time difference between the readout and deadline for the submission of an admissible guess. Furthermore, this security feature also allows a transmission of a guess after the end of the event, since delayed inputs (knowing the result) can be determined by the game organizer by using the device time in the above manner.

As an option, a storage of all relevant game steps and inputs in the documentation memory 15 may be effected by the lock key 10.

### Example 4

### The Quiz Function

This function may for instance be used for a multiple-choice (mc) quiz. A mc quiz is a quiz, wherein a player has to input a letter or a (one-digit) number as an answer to a question, the letters or numbers being assigned by the game organizer to several offered answers. It may be provided that only one answer is correct, however several correct answers to one question are also possible. Further, so-called series questions are possible, where the answer is a defined order of letters or numbers assigned to the asked order (example: question: decreasing size of ball? A: soccer ball, b: tennis ball, c: golf ball, d: volleyball; correct answer: adbc).

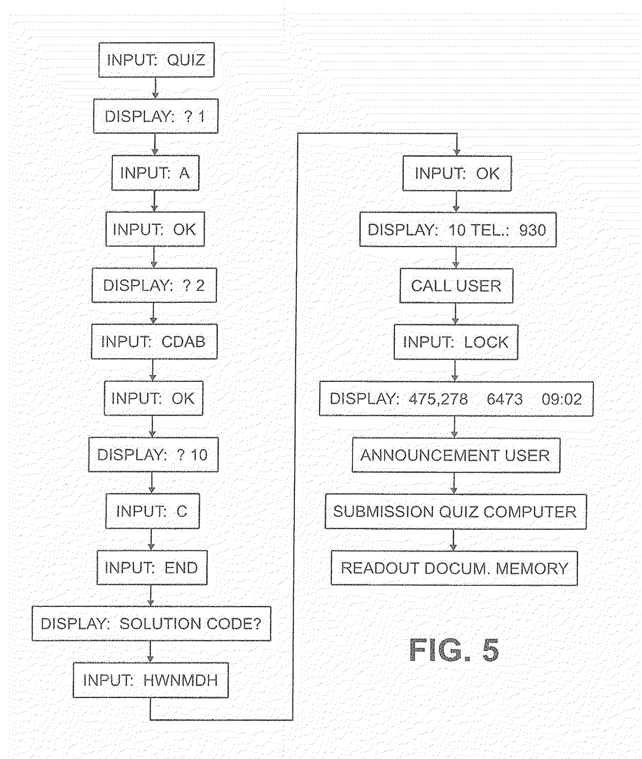

For the game function mc quiz, the following described steps are integrated in the operating program. These steps are also made clear in FIG. 5. The game is initialized by pressing the quiz key 4, and thus the respective operating program part is invoked. Hereby, the device time is initialized, too.

After pressing the quiz key 4, in the display 12 appears a request for inputting the first answer to a question being asked for instance in a quiz show with defined alternative answers or orders. In the display 12 may appear a “1” as a hint to the first question or answer. The user then inputs the letter for the—in his opinion—correct answer (or a sequence of letters for the assumed correct order in a series question). After inputting the answer, this is terminated by actuation of the OK key 8. Then appears a “2” with the request for inputting the second answer etc. After inputting the last answer, the quiz is terminated with the actuation of the end key 9. Thereafter the input of a solution code is required by means of the display 12.

The solution code is determined by the game organizer by using the correct answers and is announced after the end of the quiz. The solution code may for instance be established as follows.

Let's assume 10 questions with an answer depth of A to D (mc). The correct answers then result in the order of the questions, for instance CDABDAADCC. If A=1, B=2, C=3 and D=4, then the number sequence 34 12 41 33 is obtained. If these groups of 2 are transformed with the matrix

11=A 12=B 13=C 14=D

21=E 22=F 23=G 24=H

31=I 32=J 33=K 34=L

41=M 42=N 43=O 44=P

then the solution code LBMDK is obtained. In addition, a digit of the solution code can be used for the transmission of information about the duration of the game. When this is for instance 8 min, and the letter H is assigned to this value, then the solution code LBMDKH is obtained. It is understood that the above assignments, groupings and the matrix elements can be varied in an arbitrary manner.

With the requests for inputting the solution code, the operating person will first of all have to wait for the announcement of the solution code by the game organizer. Then the input is performed, which is terminated by means of the OK key 8. Simultaneously with the actuation of the OK key, the device time is stopped and thus a game duration time difference is determined or detected and stored. Then by means of the above matrix which is of course also stored in the quiz computer, the sequence of numbers correlated herewith is determined from the solution code, that is 3412411433. The computer unit of the quiz computer compares the result of these operations digit for digit with the sequence of numbers, which has been obtained from the input answers, and determines the number of correct answers by the agreements. If from the input answers 3412411433 is obtained, then all 10 answers are correct. If the sequence of numbers were 1412211431, then only 7 answers were correct. The number of correct answers from the above evaluation can then be shown on the display 12 and represent the control data. Simultaneously, a confirmation number is calculated from the solution code (for instance by division of the sequence of numbers from the solution code by a defined divisor and a defined selection and combination of digit values from the result of the division, if applicable with further following operations) and at least a part hereof is shown on the display as a telephone number for the case that all answers are correct. For instance the result of the above operation may be 930,475,278, and the confirmation number part 930 is displayed as the extension number. Hereby, only users having correctly answered all questions can call the game organizer. It is also possible to display the telephone number in the case of a defined smaller number of correct answers. Then it is recommended to assign for instance several different divisors to the numbers of correct answers, so that at last for each number of correct answers a different telephone number is shown.

Then the user will call the telephone number, whereupon he is required to actuate the lock key 10. Thereby, all desired data about the course of the game are stored in the documentation memory 15. As an option, the generation and storage of a random number, as an option with the time difference as an input value, can be initialized. The actuation will also cause the display of the (second) confirmation key determined before, for instance obtained by truncation as 475,278. Then the user is required by the game organizer to again press the lock key 10, whereby random number and time difference are displayed (this may however also happen already before). All above displays are then transmitted to the game organizer and stored at his location. The confirmation number can also be used for further comparisons. It may be provided that in parallel to the determination of the time difference, the device time still continues running. At the occasion of the storage of the course of the game in the documentation memory, the time difference belonging to every answer input since the initialization can also be stored.

In the case of a (high) winning prize and agreement even in the confirmation number, the quiz computer is collected by the game organizer, and all data are read out from the documentation memory 15 and checked. If for instance the game duration time difference (actual time difference) falls below a minimum time (desired time difference), an input not meeting the rules of the game can be detected. This may for instance be caused by that a person first writes down the questions, without initializing the quiz computer, establishes the solution during the game or has somebody else establish them, and quickly inputs one after the other the correct answers at the end of the game after initialization. As an additional security feature against such a behavior it may also be provided that the time function of the quiz computer is used for blocking further inputs after every individual input of an answer for a certain time span, for instance 10 s, so that a “quick input” of all answers is not possible. The continuing device time can in turn be used as a further check for the determination of the actual game start of the user, as explained above in connection with the function “TIPP”. On a whole, an extreme security against manipulations and violations of the rules of the game by a user is achieved.

It is of course also possible to input answers in plain text, if the game organizer has provided this (standard quiz). Further, in a quiz the variants standard and mc can be combined. These variants require of course adapted algorithms in connection with the solution code, which can however easily be established by the man skilled in the art and can also be varied relative to the above specific examples.

It is also possible that the control number and/or the confirmation number comprises non-displayable components, which are (only) stored in the documentation memory 15 and are thus only accessible to a readout by the game organizer.

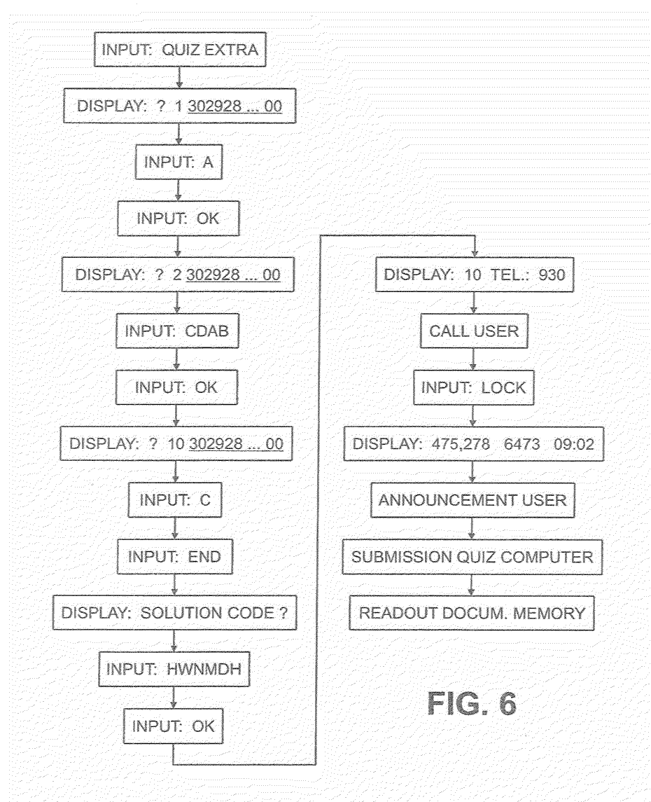

Another variant of the function quiz is that the user is required by the game organizer to actuate for instance the quiz key 4 at a defined time, in particular at the beginning, within a game plan. Hereby the device time is initialized, as described above. The same takes place at the game organizer's location, so that synchronism of the respective device times exists. The game organizer then asks the questions, for instance at defined times within the game plan. The operating program is coded such that a user has a limited time only for answering a question (guessing time difference). This may be visualized for the user by showing the remaining seconds in the display 12. After expiration, the program changes to the next request for answering a subsequent question, and this takes place compulsorily and without any possibility to interfere by a user. No answer is detected and evaluated as wrong by the operating program. No answer may however also be replaced by the operating program by a random answer, generated with the random generator (and consequently with a high probability wrong). Other substitution algorithms are also imaginable. After the last question, the user is required to input the solution code in the above described manner. By the announcement by the game organizer, the device time is stopped by the game organizer, and the thus obtained desired time difference with regard to the beginning of the game is stored. In the quiz computer, a stop of the device time occurs with the input of the solution code, for instance of the last actuation of a letter key 2 of the solution code input, or of the subsequent actuation of the OK key 8. This is then the actual time difference. The game organizer checks then for reliability by query or readout of the actual time difference stored in the documentation memory 15 and comparison with the desired time difference. Admissible are such actual time differences only, which are larger than the desired time difference. Hereby a “quick input” is prevented, as described above. In connection with the compulsory switching-on after expiration of the respective guessing time difference, it is further achieved that the game organizer can announce the correct answer immediately after each question and expiration of the guessing time difference. The processes are shown in FIG. 6.

Alternatively to the above examples, a representation and transmission of different values may take place as follows. When a user calls a call center, he is required to confirm by a letter key, then a value (e.g. control number, device time, random time etc.) is shown on the display and advised by the user by telephone. Then follows the request for confirmation of another letter key, the display of another value, the transmission thereof etc., until all values required by the call center are transmitted. Insofar the actuations of the letter keys also have the function of an operator code (thus known to the user).

Furthermore, it is possible, in deviation from the details explained above, for a “virtual” quiz computer operating on a PC or the like, to use other security features. Here, on one hand, the computer capacity is no limiting feature (anymore), and on the other hand, the possibility is offered to download on the short term algorithms or sections thereof from the internet. Thus it is for instance possible to make available an algorithm for the calculation of a control number, confirmation number etc. only on the short term by the game organizer for downloading. When the algorithm is sufficiently comprehensive and/or comprehensively protected, what is easy with usual means, then a so-called hacker will not be able to decrypt the algorithm, at least not in the time available for the determination of a winner. Decrypting later is however useless, since in a subsequent game a different algorithm or section thereof is to be downloaded. In such cases, further security features, such as device time, are not required.

### Example 5

### Coding a Transmission of a Device Time without a Random Number

If an operating person is required after the end of the game for another key actuation, the device time initialized by the first key actuation is either stopped and stored, or with continuing device time, the value of the device time existing at the time of the second key actuation is stored.

Let us assume that between the first and the second key actuation 3,600 cycles (decimal) have passed. The operating program of the computer unit then transforms the number 3,600 (existing in a binary or decimal form) into a number of a number system with the base 36, the transformation from the decimal system being made as follows: “0”=“A” . . . “25”=“Z” and “26”=“0” . . . “35”=“9”. The number 3,600 is split up into two blocks of three, namely “3” and “600”. Then 3/36=0*36+3=“D” and 600/36=16*36+24=“QY”. As the coded device time, “DQY” is obtained; the result has three digits only, without loss of information.

For a corresponding transformation of 10,800 (decimal) cycles and a number system with the base 26 (“0”=“A” . . . “25”=“Z”), the following results. Splitting-up into blocks of two “1” and “08” and “00”, 10/26=0*26+10=K and 08/26=0*26+8=I and 00/26=0*26+0=A. The code is “KIA”.

### Example 6

### Coding a Transmission of a Device Time with a Random Number

With the second key actuation or a key actuation separate herefrom, a random number is generated. Let us assume this to be 1,574. The cycle values of example 5 are multiplied herewith; then result as a code base 3,600*1,574=5,666,400 and 10,800*1,574=16,999,200.

Under application of the respective coding method of example 5 is obtained: i) 3,600: splitting-up into “5”, “666” and “400”; 5/36=0*36+5=F, 666/36=18*36+18=SS, 400/36=11*36+4=LE; code “FSSLE”, ii) 10,800: splitting-up into “16”, “99”, “92” and “00”; 16/26=0*26+16=Q, 99/26=3*26+21=DV, 92/26=3*26+14=DO and 00/26=0*26+0=“AA”; code “QDVDOAA”.

### Example 7

### Guessing Game without Telephone Registration with Input Before the Event to be Guessed

With regard to the guessing game, reference is made to example 3. Different from the approach described there, the operating person of the quiz computer is required, in case of a telephone registration, to another key actuation, the device time being subjected to a routine according to example 5 or 6 at the time of the second key actuation. The operating person informs the game organizer about the obtained code (in addition to control or confirmation code according to example 3), and the game organizer will perform in turn a back-transformation and comparison to the reference time. For control purposes, the process of the second key actuation, coding, transmission, decoding, comparison etc. may be repeated with the device time continuing running. The game organizer thus obtains, without having to collect and analyze the quiz computer, an information about potential cheaters. For increasing the security, in case of a result of the telephone checks being positive for the operating person, the quiz computer may be collected and analyzed. During the analysis, the stored codes, if applicable including the random number, are read out. A storage of codes or random number by an operating person is prevented by constructional designs of the quiz computer, so that a cheating operating person even with knowledge of the coding algorithms will be unmasked at the latest at the analysis of the quiz computer.

In an analogous manner, bingo or guessing games can be performed according to examples 2 and 4, and the game organizer is able to check by the coded device time the keeping of an earliest or latest-admissible input by telephone. The actual input is determined by the first key actuation (which can be hidden by another function) or by the clock signal number expired between this and the second key actuation.

I claim:

1. A method for verifying answers of a quiz game that are input into a quiz computer, which comprises an input keyboard, an OK key, a display and a computer unit that is equipped with a read-only memory unit containing an operating program,
said operating program coding for a method for evaluating answers input by means of the input keyboard during a quiz game,
said operating program coding for the generation of control and/or confirmation data from input answers,
said operating program coding for at least one security feature from the group consisting of the generation of a device time initialized by the actuation of a key, the generation of a random data word upon actuation of a key, and the combinations of the prominent security features, and
said security feature in addition to the control and/or confirmation data being transmitted to a game organizer and verified at that location.

2. A method according to claim 1, wherein the security feature consists in the generation and indication on the display of the device time initialized by a key actuation.

3. A method according to claim 1, wherein the initialization of the device time is effected by the actuation of a letter key or a game selection key or the OK key.

4. A method according to claim 1, wherein the device time is initialized to a start value of 0.

5. A method according to claim 1, wherein the device time has the format hh:mm:ss or mm:ss.

6. A method according to claim 1, wherein the device time runs in increments of 1 to 30 s, preferably 1 to 10 s, for instance 5 s, and/or is shown on the display.

7. A method according to claim 1, wherein the running device time is not stoppable by an operation of the quiz computer or wherein the running device time is stoppable by actuation of a lock key, and the value of the stopped device time is storable in an documentation memory.

8. A method according to claim 1, wherein the device time, running or stopped, is showable on the display by means of a key actuation.

9. A method according to claim 1, wherein the device time is initialized by a defined first key actuation, wherein the device time is read out on the display as a response to a subsequent second key actuation determined by the game organizer, and is transmitted by an operator to the game organizer, wherein by the game organizer a verification of the time of the first key actuation being after or before, resp., a given earliest or latest time, resp., of an admissible input of an answer is performed by comparison of the transmitted device time to a minimum or maximum reference time, resp., calculated from the time difference between the earliest or latest time, resp., of an admissible input of an answer and the time of the second key actuation.

10. A method according to claim 1, wherein the device time is encrypted before readout, the transmitted encrypted device time being either first decrypted at the game organizer's location and then compared to the reference time or being compared to the reference time encrypted before.

11. A method according to claim 1, wherein with the second defined key actuation or a third defined key actuation, a random data word is generated, the random data word being transmitted together with the device time to the game organizer.

12. A method according to claim 1, wherein the device time is subjected before readout to a linking operation with the random data word to generate a combination data word, and wherein the combination data word is subjected by using the transmitted random data word at the game organizer's location before the comparison to an inverse linking operation, a device time being obtained thereby, or wherein the reference time with the transmitted random data word is subjected at the game organizer's location before the comparison to the linking operation.

13. A method according to claim 1, wherein the encrypted device time or the combination data word is converted into a number of a number system with a base>10, in particular >20, for instance 26 or 36.

14. A method according to claim 13, wherein the values up to 26 of the decimal system are the letters of the alphabet and as an option the values 27 to 36 of the decimal system are the numbers “0” to “9”.

15. A method according to claim 13, wherein either a reconversion of the device time or of the combination data word into the number system of the reference time is made by the game organizer before the comparison, or the reference time is converted into the number system of the device time or of the combination data word before the comparison.

16. A method according to claim 9, wherein readout and transmission of the device time, of the combination data word and/or of the random data word are performed several times in succession, for instance two times.

17. A method according to claim 1, wherein the transmission of the device time and/or the combination data word and/or the random data word is effected by telephone by an operator of the quiz computer.

18. A program coding for a method according to claim 1.

19. A quiz computer, which comprises an input keyboard, an OK key, a display and a computer unit that is equipped with a read-only memory unit containing an operating program, said operating program coding for a method according to claim 1.
